(19) United States
(12) Patent Application Publication
(10) Pub. No.: US 2013/0020273 A1
(43) Pub. Date: Jan. 24, 2013

(54) STEPLESS LUFFING MECHANISM FOR SUPER-LIFTING COUNTERWEIGHT OF CRAWLER CRANE AND OPERATING METHOD THEREOF

(71) Applicants: Zhigang Chen, Shanghai (CN); Baojun Lu, Shanghai (CN); Zhenzhu Li, Shanghai (CN); Linghua Su, Shanghai (CN)

(72) Inventors: Zhigang Chen, Shanghai (CN); Baojun Lu, Shanghai (CN); Zhenzhu Li, Shanghai (CN); Linghua Su, Shanghai (CN)

(73) Assignee: Shanghai Sany Technology Co., Ltd., Shanghai (CN)

(21) Appl. No.: 13/515,810

(22) PCT Filed: Jun. 12, 2010
(86) PCT No.: PCT/CN2010/000847

§ 371 Date: Sep. 20, 2012

(30) Foreign Application Priority Data
Jan. 26, 2010 (CN) 201010101261.4

(51) Int. Cl. B66C 23/76; G06F 11/30

(52) U.S. Cl. 212/196; 701/34.4

(57) ABSTRACT

A stepless luffing mechanism for the super-lifting counterweight of a crawler crane, and an operating method thereof. The luffing mechanism includes a main luffing mast, a lifting oil cylinder, a luffing structure and a pulling board for the counterweight, and a super-lifting mast. The cylinder's lower end is connected with the counterweight, and its upper end is connected with a lower end of a front part of the luffing structure. The upper end of the luffing structure's front part is connected with the pulling board's lower end. A lifting rope connects the pulling board's upper end with the super-lifting mast's upper end. The super-lifting mast's lower end is connected with a platform's back end. An angle measuring sensor for the main luffing mast is provided on the super-lifting mast. A lower end of a back part of the luffing structure is connected with a pin shaft of the platform.

### TECHNICAL FIELD

The present invention relates to a mechanism and it's operation method to change the position of the super-lifting counterweight of a crawler crane, specifically it relates to the stepless luffing mechanism for Super-lifting Counterweight of crawler crane and the operation method thereof.

### BACKGROUND

Presently, most crawler cranes usually change the super-lifting radius by changing the angle of Super-lifting mast, thus to change the position of super-lifting counterweight and to adjust the barycenter of the super-lifting counterweight in order to ensure the stability of the whole machine when hoisting. By only changing the angel of the super-lifting mast to achieve changing of the position of the Super-lifting counterweight, it is needed to place the super-lifting counterweight on the ground every time, and to change the angel of the Super-lifting mast thereafter, then the super-lifting counterweight will be lifted after the super-lifting radius is adjusted. Such method could not be operated in operation process, and it is not only complicated but also time-consuming, strenuous and low performing, and it requires larger working space.

### SUMMARY OF THE INVENTION

The object of the invention is to provide a stepless luffing mechanism for the super-lifting counterweight of crawler crane, which could achieve the stepless luffing for the super-lifting counterweight in working process conveniently and easily without changing the angle of super-lifting mast and without dismantling or assembling the counterweight anymore. It is easy to be operated so that the working efficiency will be increased obviously and the requirement for the working space for the super-lifting mast is reduced. And the working range of the hoisting operation is enlarged and the wobble of the super-lifting counterweight is also reduced.

In order to achieve the above said objects, the technology solution of the present invention is:

providing a type of stepless luffing mechanism for super-lifting counterweight of crawler crane, including main luffing mast, lift cylinder, variable amplitude construction for super-lifting counterweight, pulling plate for super-lifting counterweight, super-lifting mast and a measuring transducer which is mounted beneath the variable amplitude construction for super-lifting counterweight; wherein the lower end of the lift cylinder connects to the super-lifting counterweight, and the upper end of the lift cylinder connects to the lower end of the front part of the variable amplitude construction for super-lifting counterweight; the upper end of the front part of the said variable amplitude construction for super-lifting counterweight connects to the lower end of the super-lifting counterweight pulling plate; the lower end of the super-lifting mast connects to the back-end of the platform, while the upper end of super-lifting mast connects to the upper end of the super-lifting counterweight pulling plate through lifting rope; the lower end of the main luffing mast connects to the back-end of the platform, while the upper end of the main luffing mast connects separately to the upper end of the super-lifting mast as well as to the lower end in the rear side of the variable amplitude construction for super-lifting counterweight by lifting rope.

With respect to the said stepless luffing mechanism for super-lifting counterweight of crawler crane, wherein: the said variable amplitude construction for the super-lifting counterweight including the set support of the hydro-cylinder; translating hydro-cylinder(s) which is set in the front end of hydro-cylinder set support, hydro-cylinder piston rod support(s) which set in the front end of the translating hydro-cylinder(s) and connecting support(s) which is set in the front end of the hydro-cylinder piston rod support(s) and pulling plate(s) which is set in the front end of connecting support(s).

With respect to the said stepless luffing mechanism for the super-lifting counterweight of crawler crane, wherein:

the said measuring transducer includes a length sensor and an angle sensor; the said length sensor is installed at the lower part of the hydro-cylinder support to measure the projecting length of the translating hydro-cylinder; the said angle sensor is installed at the lower part of the hydro-cylinder piston rod support(s) to measure the angle between the variable amplitude construction for super-lifting counterweight and the platform.

With respect to the said stepless luffing mechanism for super-lifting counterweight of crawler crane, wherein:

the said variable amplitude construction for the super-lifting counterweight connects to the pin of the platform through the hydro-cylinder support; the said pulling plates include a first pulling plate and a second pulling plate, the upper ends of the first and second pulling plates connect to the upper end of the lift cylinder, and the lower ends of the first and second pulling plates connect to the lower end of the super-lifting counterweight pulling plate.

With respect to the said stepless luffing mechanism for Super-lifting counterweight of crawler crane, wherein:

there is a mast angle sensor which is set on the super-lifting mast.

With respect to the said stepless luffing mechanism for super-lifting counterweight of crawler crane, wherein:

there are pressure sensor and proportional electromagnetic valve which are set in the translating hydro-cylinder.

With respect to the said stepless luffing mechanism for super-lifting counterweight of crawler crane, wherein: the said translating hydro-cylinder drives the piston rod of the hydro-cylinder to move in the horizontal direction;

With respect to the said stepless luffing mechanism for super-lifting counterweight of crawler crane, wherein:

the said lift cylinder drives the super-lifting counterweight to move in the vertical direction;

An operation method for the stepless luffing mechanism of super-lifting counterweight of crawler crane, wherein it includes the following steps:

Step 1: calculating out the distance between the top of the super-lifting mast and the straight L1 which connects the super-lifting counterweight translating mechanism and the hinge point of the platform according to the angle α between the super-lifting mast and platform which is measured by the mast angle sensor.
Step 2: measuring the included angle ø between the super-lifting counterweight variable amplitude mechanism and the platform through the angle sensor; and calculating out the included angle β between the super-lifting counterweight variable amplitude mechanism and the straight L1 according to the measured angles α and ø.
Step 3: calculating out the distance L7 between the hinge point where the variable amplitude mechanism for the super-lifting counterweight connect the platform and the hinge point where the end of the variable amplitude mechanism for the super-lifting counterweight connect the super-lifting counterweight pulling plate according to the value of β.
Step 4: calculating out the value of the super-lifting radius R according to the value of L7 and ø.

Due to the said technologies adopted in the present invention, it has active effect comparing the prior art, such as: the present invention may realize the stepless variable amplitude of the super-lifting counterweight radius, and the range of the variable amplitude is larger, and it is more convenient, thus it could achieve the object that make hoisting operation range of the complete machine larger and the complete machine during the hanging process will be more stable, safer and more reliable. It further makes use of the space of the super-lifting mast, especially in the condition that the working space is limited. It can change the center of gravity of the super-lifting counterweight by changing the stroke of the translating hydro-cylinder, and without changing the angle position of the super-lifting stretcher, thereby the space for luffing and variable amplitude of the super-lifting mast is saved a lot. And it is easy to operate and convenient to use.

The present invention could change the strained condition of the super-lifting counterweight efficiently and decrease the wobble and the impact while the crawler crane is rotating and moving to enable its movement more stable. Thereby the using condition of the complete vehicle is improved and the working life of the complete vehicle is increased. Basing on the real-time monitoring by the sensors, the electrical program control and hydraulic pressure hydro-cylinder achievement, the moving course of the super-lifting counterweight would be more safe and placid, and the value of moving position would be more accurate to further ensure the safety of the crane. Combination with the electron loading and program control, it is available to display the radius value of the super-lifting (i.e. super-lifting counterweight position), the tension schedule of the main variable amplitude, the pressure schedule of the super-lifting counterweight lifting hydro-cylinder, the pressure schedule of the super-lifting counterweight translating hydro-cylinder and the translating stroke of the super-lifting counterweight in the comprehensive instrument displays in the driving room, so that the accurate data can be provided for operation personnel to refer when they are operating complete machine. Application of the said mechanism will observably simplify the process to change the position of the super-lifting counterweight, and the construction of the mechanism is simple and easy to be assembled, dismounted and transported.

### BRIEF DESCRIPTION OF THE DRAWINGS

FIG. 1 shows the whole construction of the stepless luffing mechanism for the super-lifting counterweight of crawler crane according to the present invention.

FIG. 2 shows the front view of the super-lifting counterweight of the stepless luffing mechanism for super-lifting counterweight of crawler crane according to the present invention.

FIG. 3 is the plan view of the variable amplitude structure for super-lifting counterweight of the stepless luffing mechanism for super-lifting counterweight of crawler crane according to the present invention.

FIG. 4 shows the calculation for super-lifting radius of the stepless luffing mechanism for super-lifting counterweight of crawler crane according to the present invention.

### DETAILED DESCRIPTION OF THE PREFERRED EMBODIMENT

The embodiments of the present invention will be further illustrated with the drawings.

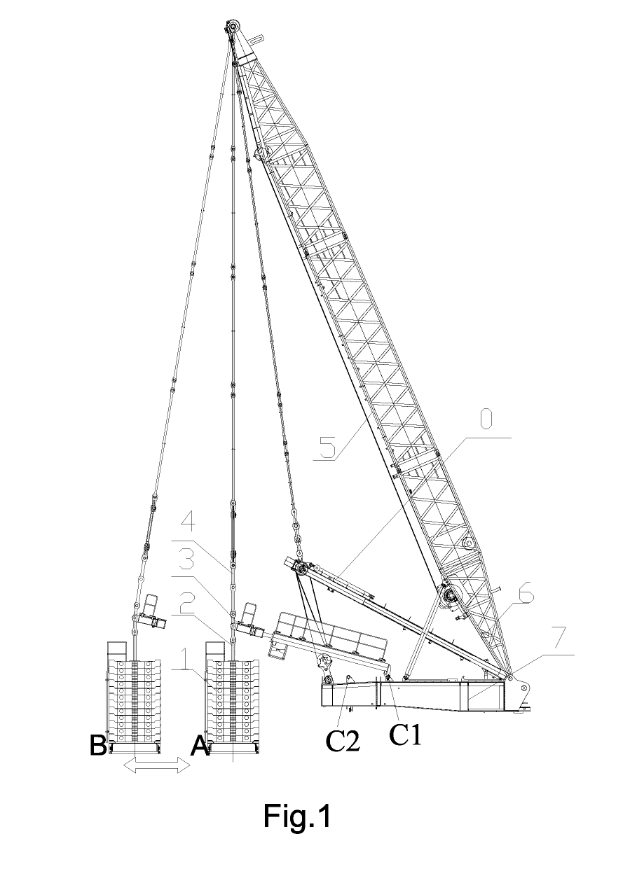

As shown in FIG. 1, a type of stepless luffing mechanism for super-lifting counterweight of crawler crane, including main luffing mast 0, lift cylinder 2, variable amplitude construction for Super-lifting counterweight 3, pulling plate for Super-lifting counterweight 4, Super-lifting mast 5 and measuring transducer 6 installed under the variable amplitude construction for Super-lifting counterweight 3. The lower end of the lift cylinder 2 connecting to the super-lifting counterweight 1, the upper end of the lift cylinder 2 connects to the lower end of the front part of the variable amplitude construction for super-lifting counterweight 3; the upper end of the front part of the variable amplitude construction for super-lifting counterweight 3 connects to the lower end of the super-lifting counterweight pulling plate 4; the upper end of the super-lifting counterweight pulling plate 4 connects to the super-lifting mast 5 by a lifting rope, and the other end of the super-lifting mast 5 connect one end of the platform 7. There is a mast angle sensor 51 set on the super-lifting mast 5. The lower end of the variable amplitude construction for the super-lifting counterweight 3 connects to the pin of the platform 7; the lift cylinder 2 drive super-lifting counterweight 1 to move in vertical direction to adjust its position along vertical direction to ensure the super-lifting counterweight 1 is at an appropriate height.

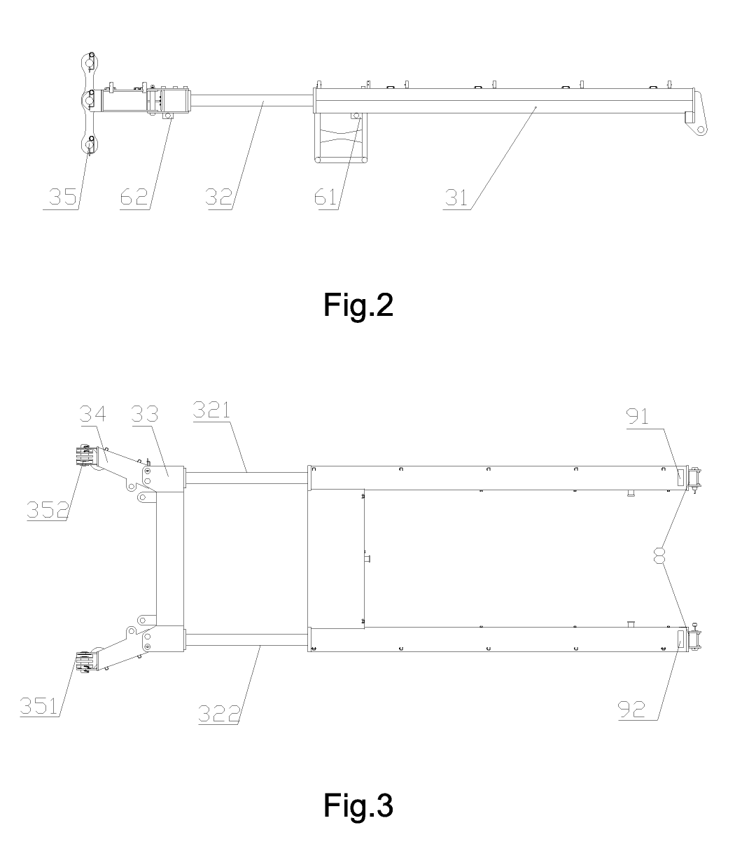

Please refer to FIG. 2 and FIG. 3, which include the hydro-cylinder support 31, translating hydro-cylinder 32 that set in the front end of the hydro-cylinder support 31, hydro-cylinder piston rod support(s) 33 that set in the front end of the translating hydro-cylinder 32, the connecting support 34 that set in the front end of the hydro-cylinder piston rod support(s) 33 and pulling plate 35, that set in the front end of the connecting support 34. Pulling plates 35 includes a first pulling plate 351 and a second pulling plate 352, the upper ends of the first pulling plate 351 and the second pulling plate 352 connect to the upper end of the lift cylinder 2, the lower ends of the first pulling plate 351 and the second pulling plate 352 connect to the lower end of the super-lifting counterweight pulling plate 4. The translating hydro-cylinder 33 drives the hydro-cylinder piston rod 331 to move in the horizontal direction. The measuring transducer 6 includes a length sensor 61 and an angle sensor 62; the length sensor 61 installed at the lower part of the hydro-cylinder support 31 to measure the projecting length the translating hydro-cylinder 32; the said angle sensor 62 is installed at the lower part of the hydro-cylinder piston rod support(s) to measure the included angle between variable amplitude construction 3 for super-lifting counterweight and the platform 7.

Please refer to FIG. 1, FIG. 2 and FIG. 3, the level position of super-lifting counterweight is adjusted through controlling the stretch of two super-lifting counterweight translating hydro-cylinders 32 of the variable amplitude mechanism for super-lifting counterweight 3 to make it far away from or close to the center of gravity of the whole vehicle in horizontal direction. It is pushed from point A to point B, or retracted from point B to point A.

When the pressure on the pulling plates of the main luffing mast 0 is lesser, the super-lifting counterweight translating hydro-cylinder 32 may do the retract stroke. When the pressure on the pulling plates of the main luffing mast 0 is suitable, the super-lifting counterweight translating hydro-cylinder 32 is at a lock position and with no movement. When the pressure on the main variable amplitude pulling plate 0 is biggish, the super-lifting counterweight translating hydro-cylinder 32 may be pushed out and the stroke is increased.

Please refer to FIG. 3, there are pressure sensor 8 and proportional electromagnetic valve 9 set in the translating hydro-cylinder 32. In order to ensure the synchronization of the movement of the two translating hydro-cylinders 3, there is a pressure sensors 8 set in the translating hydro-cylinders 32 which adopt synchronization control logic. When the translating hydro-cylinders 32 are moving, the pressures of the two hydro-cylinders 32, monitored by the pressure sensors 8 will be equal. Otherwise, they will be unequal. If the pressure of the first translating hydro-cylinder 321 is not equal to the pressure of the second translating hydro-cylinder 322, it has to be processed with the difference value between the said pressures. The process for difference value is mainly achieved by an electromagnetism valve. A first proportional electromagnetic valve 91 and second proportional electromagnetic valve 92 are separately configured in the first translating hydro-cylinder 321 and second translating hydro-cylinder 322. The speed of the hydro-cylinder action is determined by the value of given electric current. The opening of the electromagnetism valve will be bigger when the electric current is higher, thus the speed of the hydro-cylinder action will also be quicker; the opening of the electromagnetism valve will be smaller when the electric current is lower, thus the speed of the hydro-cylinder action will also be slower. Therefore, the speed of the hydro-cylinder action is changed by adjusting and controlling the electric current of the first proportional electromagnetic valve 91 and the second proportional electromagnetic valve 92 set in the first translation hydro-cylinder 321 and second translation hydro-cylinder 322 in order to achieve the synchronization finally.

The length sensor 61 and the angle sensor 62 separately monitor the length value of variable amplitude mechanism for super-lifting counterweight 3 and the value of the included angle ø between the variable amplitude mechanism for super-lifting counterweight 3 and the platform 7 in real time. And the value of super-lifting radius can be calculated out, i.e. the position value of the super-lifting counterweight.

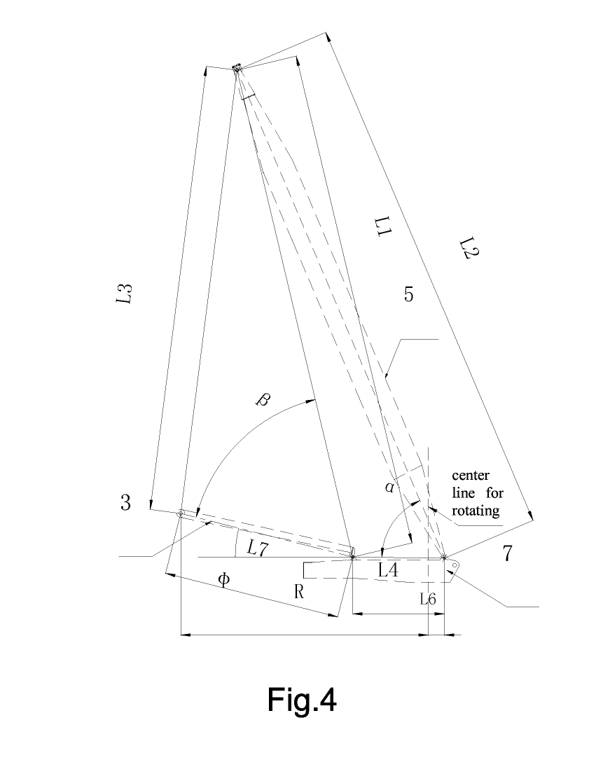

Please refer to FIG. 4, and the calculating method for the super-lifting counterweight working radius as follows:

The radius of super-lifting: R=L7×cos φ+L4−L6 wherein:

L2—the length of the super-lifting mast;
α—the angle of the super-lifting mast (examined by the sensor for the angle of the super-lifting mast);
ø—the angle of the super-lifting counterweight variable amplitude mechanism (examined by the angle sensor);
L4—the distance between the hinge point of the super-lifting mast and the hinge point of the super-lifting counterweight translating mechanism;
L3—the distance between the hinge point of the super-lifting mast and the hinge point where the end of the super-lifting counterweight variable amplitude mechanism connects the pulling plate;
L6—the distance between the hinge point of the super-lifting mast and the centre line for rotating;
L1—the distance between the top of the super-lifting mast and the hinge point of the super-lifting counterweight translating mechanism;

L1=\sqrt{L2²+L4²−2×L2×L4×cos α}

L7—the distance between the hinge point of the super-lifting counterweight variable amplitude mechanism and the hinge point where the end of the super-lifting counterweight variable amplitude mechanism connects the pulling plate;

L7=L1×cos β+\sqrt{L3²−L1²×sin β²}

β=α sin(L2×sin α/L1)−φ

A method for operating The stepless luffing mechanism, including following steps:

Step 1: calculating out the value of straight line L1 according to the value of α which is measured by the mast angle sensor 51.
Step 2: calculating out the value of β according to the value of ø which is measured by the angle sensor.
Step 3: calculating out the value of L7 according to the value of β;
Step 4: calculating out the value of the super-lifting radius R according to L7 and the value of ø.

When the super-lifting counterweight stepless luffing mechanism of crawler crane moves between point A and point B, its measuring transducer 6 for the working radius examins, programs to calculate (according to the above formulas), transports the data and displays in real time on the screen of the driver's cab for the operator to monitoring in real time.

The present invention may realize the stepless variable amplitude of super-lifting counterweight radius. And the variable amplitude range is larger and more convenient so that it could achieve the object that makes hoisting operation range of the complete machine larger and the complete machine more stable, safer and reliable in the hoisting operation. It further makes use of the operation space of the super-lifting mast, especially in the condition that the working space is limited, the center of gravity of the super-lifting counterweight may be changed through changing the stroke of the translating hydro-cylinder and without changing the angle position of the super-lifting mast. Thereby the space for variable amplitude of the Super-lifting mast can be saved obviously. And it is also easy to operate and convenient to use.

1. A stepless luffing mechanism for a super-lifting counterweight of a crawler crane, including
a main luffing mast,
a lift cylinder,
a variable amplitude construction for the super-lifting counterweight,
super-lifting counterweight pulling plates; and
a super-lifting mast, wherein:
a lower end of the lift cylinder connects to the super-lifting counterweight, and an upper end of the lift cylinder connects to a lower end of a front part of the variable amplitude construction for the super-lifting counterweight, and
an upper end of the front part of the variable amplitude construction for the super-lifting counterweight connects to a lower end of the super-lifting counterweight pulling plates; and
a measuring transducer fitted under the variable amplitude construction for the super-lifting counterweight.

2. The stepless luffing mechanism for a super-lifting counterweight of a crawler crane according to the claim 1, further comprising
a platform having a back end connected to a lower end of the super-lifting mast; and
a first lifting rope connecting the upper end of super-lifting mast to the upper end of the super-lifting counterweight pulling plates;
wherein the lower end of the main luffing mast connects to the of the platform back end, the upper end of the main luffing mast separately connects to
the upper end of the super-lifting mast, and
a lower end of a rear side of the variable amplitude construction for the super-lifting counterweight by a second lifting rope.

3. The stepless luffing mechanism for a super-lifting counterweight of a crawler crane according to the claim 1, wherein the variable amplitude construction for the super-lifting counterweight includes a hydro-cylinder support, further comprising
a translating hydro-cylinder, which is set in the front end of hydro-cylinder support;
at least one hydro-cylinder piston rod support which is set in the front end of translating hydro-cylinder;
at least one connecting support, which is set in the front end of the at least one hydro-cylinder piston rod support and
further pulling plates, which are set in the front end of the at least one connecting support.

4. The stepless luffing mechanism for a super-lifting counterweight of a crawler crane according to the claim 3, further comprising a platform having a back end connected to a lower end of the super-lifting mast, wherein:
the measuring transducer includes a length sensor and an angle sensor;
the length sensor is installed at the lower part of the hydro-cylinder support to measure the projecting length of the translating hydro-cylinders; and
the angle sensor is installed at the lower part of the hydro-cylinder piston rod support to measure the included angle between the platform and the variable amplitude construction for the super-lifting counterweight.

5. The stepless luffing mechanism for a super-lifting counterweight of a crawler crane according to the claim 1, wherein:
the variable amplitude construction for the super-lifting counterweight connects to a pin of the platform by the hydro-cylinder support;
the further pulling plates include a first pulling plate and a second pulling plate,
an upper end of the first pulling plate and second pulling plate connect to the upper end of the lift cylinder, and
the lower end of the first pulling plate and second pulling plate connect to the lower end of the super-lifting counterweight pulling plate.

6. The stepless luffing mechanism for a super-lifting counterweight of a crawler crane according to the claim 1, further comprising a mast angle sensor set on the super-lifting mast.

7. The stepless luffing mechanism for a super-lifting counterweight of a crawler crane according to the claim 1, further comprising at least one pressure sensor and a proportional electromagnetic valve set in the translating hydro-cylinder.

8. The stepless luffing mechanism for a super-lifting counterweight of a crawler crane according to the claim 1, wherein:
the translating hydro-cylinder drives the piston rod of the hydro-cylinder to move in the horizontal direction.

9. The stepless luffing mechanism for a super-lifting counterweight of a crawler crane according to the claim 1, wherein:
the lift cylinder drives the super-lifting counterweight to move in the vertical direction.

10. An operation method for stepless luffing mechanism of super-lifting counterweight of crawler crane, wherein:
Step 1: calculating out the distance between the top of the super-lifting mast and the straight L1 which connects the super-lifting counterweight translating mechanism and the hinge point of the platform according to the angle α between the super-lifting mast and platform which is measured by the mast angle sensor;
Step 2: measuring the included angle ø between the super-lifting counterweight variable amplitude mechanism and the platform through the angle sensor; and calculating out the included angle β between the super-lifting counterweight variable amplitude mechanism and the straight L1 according to the measured angles α and ø;
Step 3: calculating out the distance L7 between the hinge point where the variable amplitude mechanism for the super-lifting counterweight connect the platform and the hinge point where the end of the variable amplitude mechanism for the super-lifting counterweight connect the super-lifting counterweight pulling plate according to the value of β;
Step 4: calculating out the value of the super-lifting radius R according to the value of L7 and ø.

11. The stepless luffing mechanism for a super-lifting counterweight of a crawler crane according to the claim 1, further comprising a platform having a back end connected to a lower end of the super-lifting mast, wherein:
the measuring transducer includes a length sensor and an angle sensor;
the length sensor is installed at the lower part of the hydro-cylinder support to measure the projecting length of the translating hydro-cylinders; and
the angle sensor is installed at the lower part of the hydro-cylinder piston rod support to measure the included angle between the platform and the variable amplitude construction for the super-lifting counterweight.
